(19) United States
(12) Patent Application Publication
(10) Pub. No.: US 2022/0003416 A1
(43) Pub. Date: Jan. 6, 2022

(54) ASH MANAGEMENT SYSTEM

(71) Applicant: GHP Group, Inc., Niles, IL (US)

(72) Inventors: Daniel S. Choi, Niles, IL (US); Aaron Christopher Cox, Niles, IL (US); Owen Alan Slater, Niles, IL (US); Mia Flynn, Niles, IL (US)

(73) Assignee: GHP Group, Inc., Niles, IL (US)

(21) Appl. No.: 16/918,021

(22) Filed: Jul. 1, 2020

(51) Int. Cl. F24B 1/191; A47J 37/07; F24B 1/193

(52) U.S. Cl. CPC F24B 1/1915; F24B 1/193; A47J 37/0786

(57) ABSTRACT

Disclosed is an ash or debris management system for an appliance such as a charcoal grill. The system includes a sifter tray with openings that can be exposed by manually or automatically oscillating the sifter tray back and forth. The sifter tray can include ridges with angled faces that push the debris toward the sifter openings to better facilitate movement of the debris. In this manner, debris such as ash can be removed from the appliance with ease.

### TECHNICAL FIELD OF THE INVENTION

The presently disclosed embodiments relate generally to outdoor cooking appliances. More particularly, the presently disclosed embodiments relate to an ash management system for an outdoor cooking appliance such as a grill or smoker.

### BACKGROUND OF THE INVENTION

Outdoor cooking appliances are prevalent in today's cooking arsenal. Many amateur and professional cooks utilize grills, smokers, griddles, and pizza ovens that are primarily meant to be used outdoors. These appliances combust various forms of fuel such as charcoal or gas, and based on that combustion, heat the food to a cooking temperature. Some outdoor cooking appliances are designed to combust fuel for long periods of time, sometimes many hours, to cook the food according to a particular process and to a target temperature.

Various fuel sources yield ash or other byproducts that must be removed from the appliance. For example, a pellet grill or charcoal grill combusts wood products for heat and flavor, and as a result, yield ash as a byproduct. Even gas grills may yield a physical byproduct when food remnants brake off or are converted to ash.

Grilling byproducts must be cleaned or otherwise removed from the grill. In this manner, several existing grill mechanisms include a rotating member that selectively exposes holes in a bottom of the grill to allow ash or other byproducts to fall based on the force of gravity. A need exists, however, to better facilitate the movement of byproducts to these holes so that they may better clear the outdoor cooking appliance of unwanted debris.

### SUMMARY OF THE INVENTION

The presently disclosed embodiments include an ash management system for an appliance. The system includes a sifter tray with sifter openings where ash or other byproducts can fall through when the sifter tray is positioned in the clearing position. The sifter tray can also include ridges that push debris toward the sifter openings and that are angled upward so as to use gravity to pull the debris toward the sifter openings. A user can selectively activate the sifter tray or the tray can be automatically or electrically controlled. In this manner, debris can be better removed from an appliance such as a charcoal grill with relative ease.

In particular, the presently disclosed embodiments include an appliance having a base, a firebox located within the base and including alternating planks and firebox openings extending along a longitudinal direction of the firebox, an ash pan movably coupled to the base underneath the firebox, and a sifter tray movably disposed on the firebox and including ridges and sifter openings alternating along a longitudinal axis of the sifter tray. The ridges are aligned with the firebox openings and the planks are aligned with the sifter openings in a cooking position, and the ridges are aligned with the planks and the firebox openings are aligned with the sifter openings in a clearing position.

The presently disclosed embodiments further include a method of managing debris in an appliance including manipulating a handle to cause a sifter tray to move in a first direction, the sifter tray being disposed on a firebox having alternating planks and firebox openings extending along a longitudinal direction of the firebox, and the sifter tray including ridges and sifter openings alternating along a longitudinal axis of the sifter tray, causing the debris to fall through the sifter openings and firebox openings based on the step of manipulating by aligning the sifter openings and the ridges with the planks and the firebox openings with the sifter openings, moving the handle in a second direction opposite the first direction so as to align the ridges with the firebox openings and the planks with the sifter openings, and repeating the steps of manipulating, causing, and moving.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a front perspective view of an appliance according to at least some of the presently disclosed embodiments.

FIG. 2 is a top perspective partially exploded view of an appliance according to at least some of the presently disclosed embodiments.

FIG. 3 is a top perspective view of an appliance with the lid removed according to at least some of the presently disclosed embodiments.

FIG. 4 is a top view of an appliance with the sifting tray in the cooking position according to at least some of the presently disclosed embodiments.

FIG. 5 is a top view of an appliance with the sifting tray moving from the cooking position to the clearing position according to at least some of the presently disclosed embodiments.

FIG. 6 is a top view of an appliance with the sifting tray in the clearing position according to at least some of the presently disclosed embodiments.

FIG. 7 is an enlarged bottom perspective view of a portion of the appliance with a handle in the cooking position according to at least some of the presently disclosed embodiments.

FIG. 8 is an enlarged bottom perspective view of a portion of the appliance with a handle in the clearing position according to at least some of the presently disclosed embodiments.

FIG. 9 is a partially exploded front perspective view of an appliance with the lid and ash pan removed according to at least some of the presently disclosed embodiments.

### DETAILED DESCRIPTION OF THE EMBODIMENTS

While this invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated. As used herein, the term “present invention” is not intended to limit the scope of the claimed invention and is instead a term used to discuss exemplary embodiments of the invention for explanatory purposes only.

The presently disclosed embodiments include an ash or debris management system for an appliance. The system includes a sifter tray that can be manually or automatically oscillated back and forth by a user to expose openings in the sifter tray and push debris towards those openings. The sifter tray can include ridges with angled faces that push the debris toward the sifter openings to better facilitate movement of the debris.

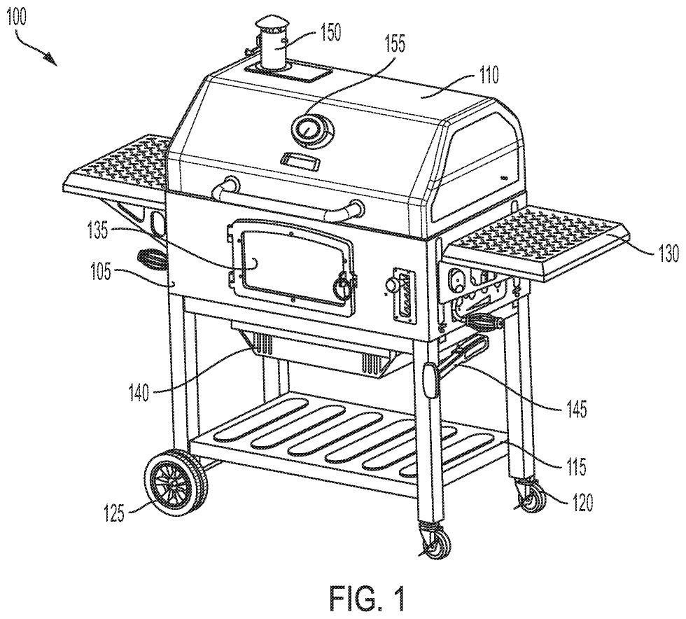

FIG. 1 is a front perspective view of an appliance 100 according to at least some of the presently disclosed embodiments. As shown, the appliance 100 includes a base 105 and a lid 110 rotatably coupled to the base 105. The base 105 can include a lower tray 115 for storage purposes and also to provide structural stability to the appliance. Proximate one side of the tray 115 can be caster wheels 120 that can be selectively locked in position, and on another side of the tray 115 can be fixed wheels that are generally held in a single position without any locking mechanism. The base 105 can also include side trays 130 for holding dishes or cooking utensils, for example, for the user during the cooking process.

The appliance 100 shown in FIG. 1 is a charcoal grill, however the present invention is not so limited and can be any cooking or heating appliance. The embodiment of FIG. 1 includes a firebox door 135 leading to a firebox where charcoal is lit and combusted during the cooking process. Byproducts from this cooking process, such as ash and unlit charcoal, fall to the ash pan 140 where they can be safely removed from the appliance 100 with relative ease. For example, a handle 145 can facilitate the movement of ash into the pan 140 by causing a sifter tray to sift the ash through openings in the tray, as discussed below in more detail. The appliance 100 can also include a chimney 150 for releasing smoke and heat from the appliance 100, and a thermometer 155 for determining the temperature of the cooking area under the lid 110.

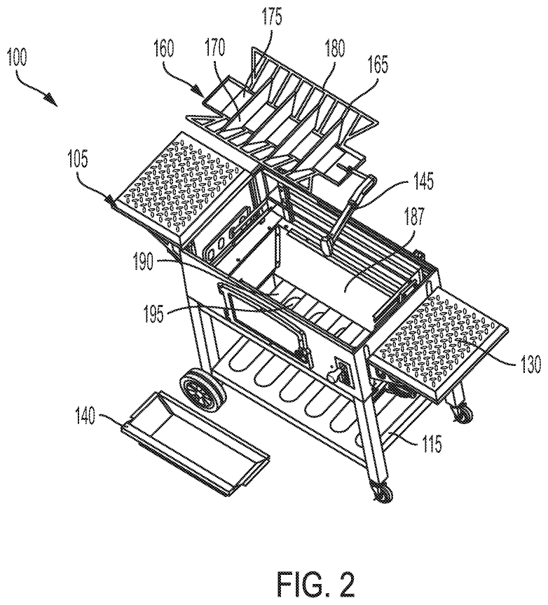

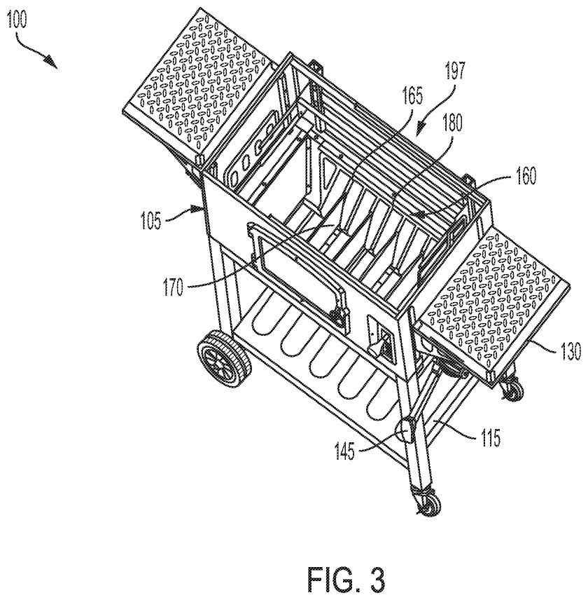

FIG. 2 is a top perspective partially exploded view; and FIG. 3 is a top perspective partially exploded view of the appliance 100, according to at least some of the presently disclosed embodiments. As shown, the appliance 100 can include a sifter tray 160 that the user can oscillate back and forth with the handle 145 to cause debris such as ash to fall to the ash pan 140. As shown, the sifter tray 160 includes a frame 165 that acts as the structural backbone of the sifter tray 160, and ridges 170 and sifter openings 175 alternating along a longitudinal length of the sifter tray 160. The frame 165 can also include a sifter incline 180 positioned at an incline with respect to the ridges 170 and sifter openings 175, and positioned adjacent a firebox incline 185 extending upward from the ridges 170. The sifter incline 180 can therefore facilitate the flow of debris toward the sifter openings 175 and ultimately into the ash pan 140. A firebox 187 can include the firebox inclines 185 leading to planks 190 and firebox openings 195 alternating along a longitudinal length of the firebox 187.

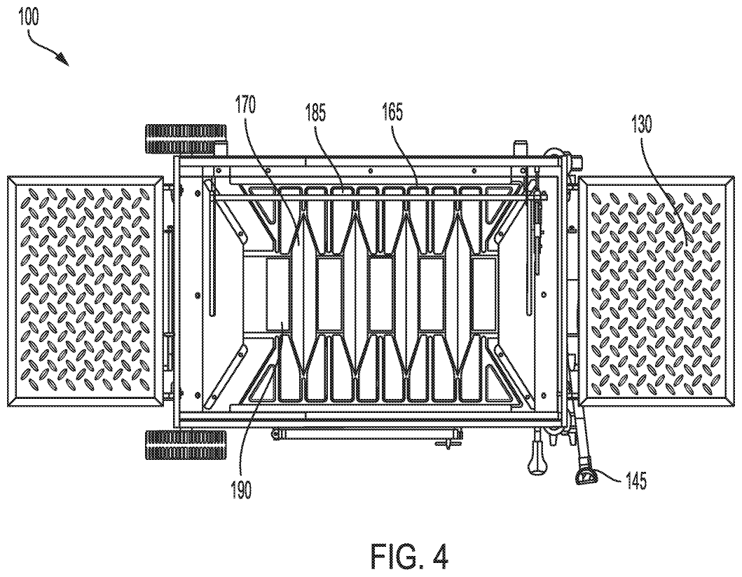

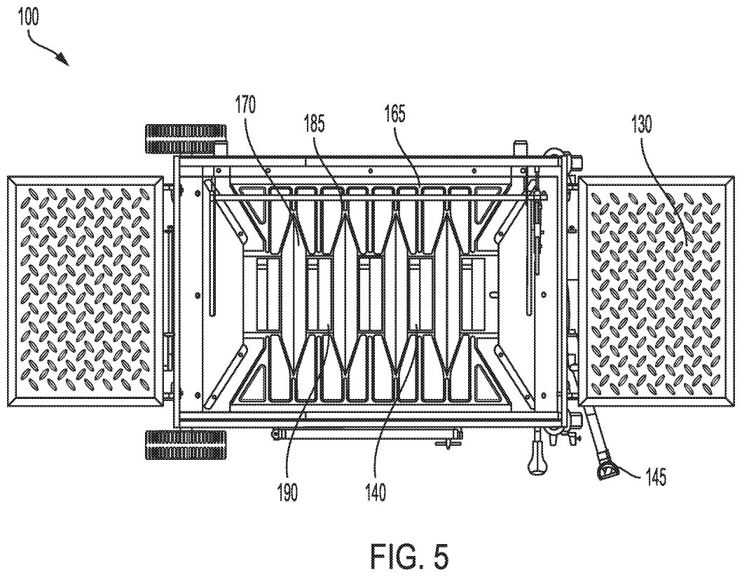

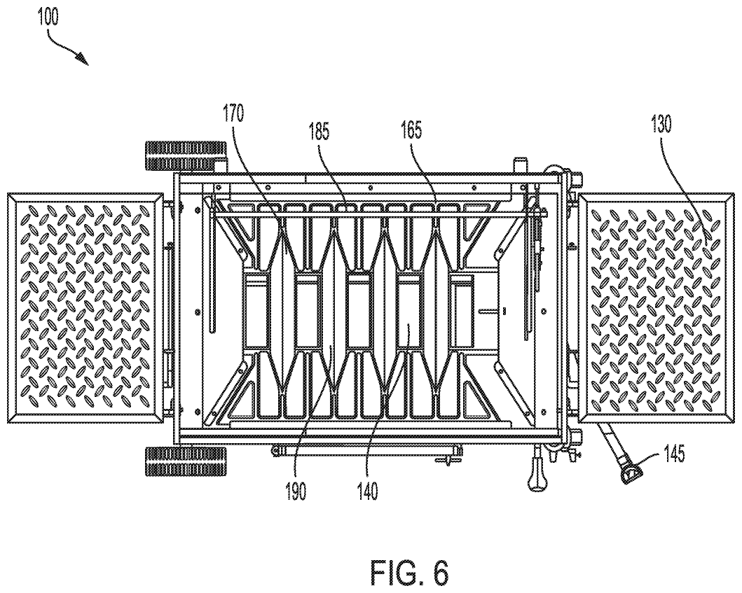

A process for operating the sifter tray 160 will be discussed with reference to FIGS. 4-9. As shown, the user can manipulate the handle 145 and push the sifter tray 160 from the cooking position, as shown in FIG. 4 to the clearing position, as shown in FIG. 6, with FIG. 5 illustrating an intermediate position of the sifter tray 160 where the tray is moving from the cooking to clearing position. As shown, ash or other debris can fall down the sifter incline 180 due to the force of gravity, and become trapped between the ridges 170 and planks 190. Thereafter, the user can manipulate the handle 145 to push the debris with the ridge 170 and, in doing so, move the ridges 170 over the planks 190 and align the sifter openings 175 with the firebox openings 195. The angled nature of the ridges 170 will cause ash and debris to be pushed in the direction of the openings 175, 195 and into the ash pan 140 below. To remove further debris and ash, the user need only move the handle 145 back and forth again until all ash or debris is cleared into the ash pan 140.

As shown, the user begins in FIG. 4 with the appliance 100 in the cooking position. Here, ash or other debris is generally prevented from flowing through the openings 175, 195 into the ash pan 140 below by the planks 190. In FIG. 5, the user has pulled on the handle 145 such that the ridges 170 align overtop the planks 190 and begin to align the sifter openings 175 with the firebox openings 195. Here, the ridges 170 begin to push the debris towards the openings 175, 195 and into the ash pan 140. In FIG. 6, the openings 175, 195 are generally overlapping in their entirety so as to allow full clearing of the debris. In many cases the user will need to oscillate the handle 145 back and forth to repeat this process, for example, to cause debris located on the ridges 170 or the sifter incline 180 and firebox incline 185 to fall down through the force of gravity. Once a user is satisfied that a substantial amount of debris has fallen to the ash pan 140, the ash pan 140 can be removed.

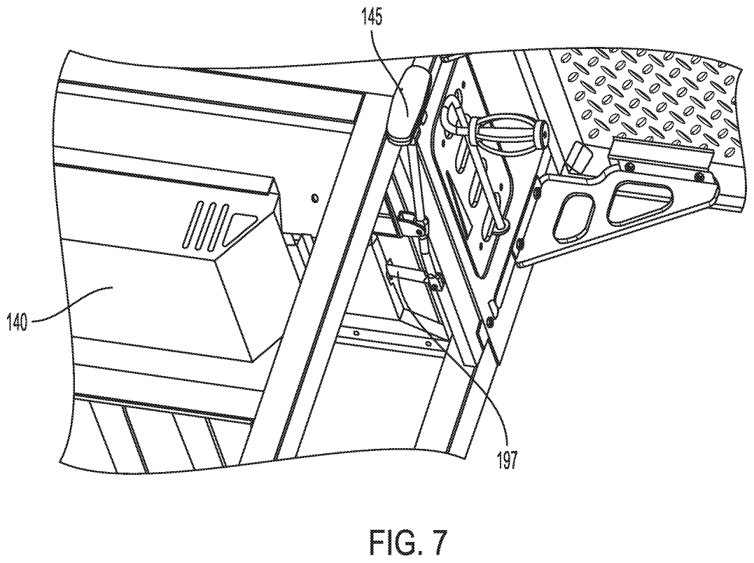

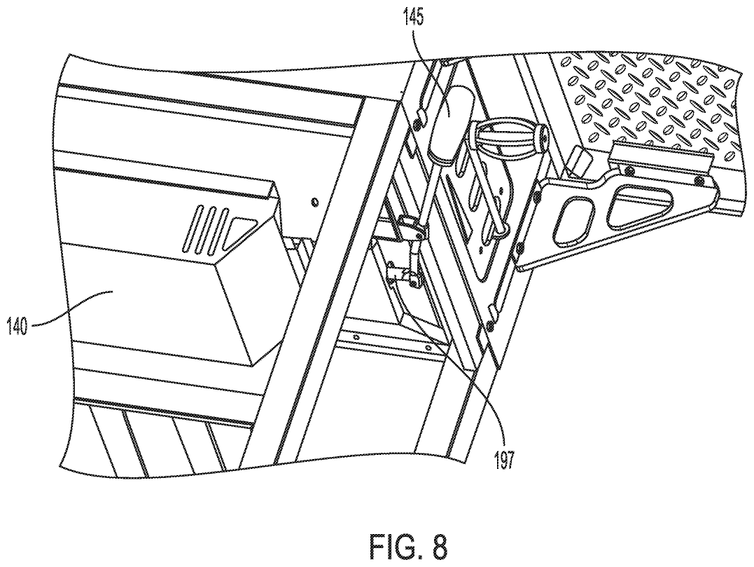

As shown in FIG. 7, the handle 145 can be coupled to the sifter tray 160 by a link 197. The user can manipulate the sifter tray 160 to clear ash and debris by moving the handle 145 back and forth, which then causes the sifter tray 160 to move axially along the longitudinal direction, as shown in FIGS. 4-6. For example, the handle 145 can be pulled outward so as to push the sifter tray 160 inward, as shown in FIG. 8. Any other method of manipulating the sifter tray 160 can be implemented without departing from the spirit and scope of the present invention. For example, the handle 145 can be omitted and the sifter tray 160 can be manipulated by an electronic control, through a user's smart phone or computer, or through a central control panel on the appliance 100.

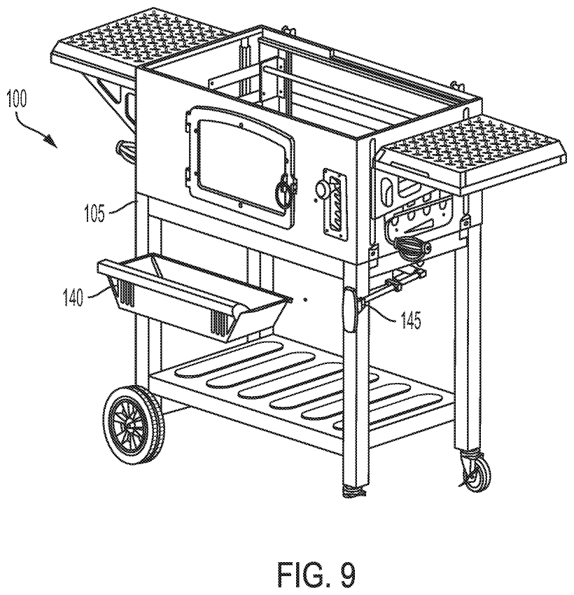

As shown in FIG. 9, the ash pan 140 can be slidably inserted into the base 105 for easy removal of ash and other debris. However, the ash pan 140 is not so limited and can be movably coupled to the base in any manner that allows easy removal of ash or other debris. For example, the ash pan 140 can be rotatably coupled to the base, coupled via magnets or other electromagnetic force, or can be coupled through any other manner.

As discussed herein, the present invention may include functionality for facilitating the removal of ash from an outdoor cooking appliance. However, the present invention is not so limited and can remove any grilling byproduct, or any other object, through the disclosed mechanisms. The present invention is also not limited to outdoor cooking appliances and can be utilized within the indoor cooking appliance field, or with heaters, or any other appliance where it is useful to remove unwanted objects from the inside.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. An appliance comprising:
a base;
a firebox located within the base and including alternating planks and firebox openings extending along a longitudinal direction of the firebox;
an ash pan movably coupled to the base underneath the firebox; and
a sifter tray movably disposed on the firebox and including ridges and sifter openings alternating along a longitudinal axis of the sifter tray,
wherein the ridges are aligned with the firebox openings and the planks are aligned with the sifter openings in a cooking position, and the ridges are aligned with the planks and the firebox openings are aligned with the sifter openings in a clearing position.

2. The appliance of claim 1, further comprising a handle coupled to the sifter tray and allowing manual manipulation of the sifter tray.

3. The appliance of claim 2, further comprising a link coupling the handle to the sifter tray.

4. The appliance of claim 1, wherein the sifter tray includes a frame having sifter inclines extending at an incline with respect to the ridges.

5. The appliance of claim 1, wherein the ash pan is removably coupled to the base.

6. The appliance of claim 1, wherein the ash pan is rotatably coupled to the base.

7. The appliance of claim 1, wherein the ridges extend at an incline with respect to the planks.

8. A method of managing debris in an appliance comprising:
manipulating a handle to cause a sifter tray to move in a first direction, the sifter tray being disposed on a firebox having alternating planks and firebox openings extending along a longitudinal direction of the firebox, and the sifter tray including ridges and sifter openings alternating along a longitudinal axis of the sifter tray;
causing the debris to fall through the sifter openings and firebox openings based on the step of manipulating by aligning the sifter openings and the ridges with the planks and the firebox openings with the sifter openings;
moving the handle in a second direction opposite the first direction so as to align the ridges with the firebox openings and the planks with the sifter openings; and
repeating the steps of manipulating, causing, and moving.

9. The method of claim 8, further comprising a handle coupled to the sifter tray and allowing manual manipulation of the sifter tray.

10. The method of claim 9, further comprising a link coupling the handle to the sifter tray.

11. The method of claim 8, wherein the sifter tray includes a frame having sifter inclines extending at an incline with respect to the ridges.

12. The method of claim 8, wherein the ash pan is removably coupled to the base.

13. The method of claim 8, wherein the ash pan is rotatably coupled to the base.

14. The method of claim 8, wherein the ridges extend at an incline with respect to the planks.
